(19) United States
(12) Patent Application Publication
(10) Pub. No.: US 2026/0244237 A1
(43) Pub. Date: Aug. 20, 2026

(54) AMUSEMENT GAME EQUIPMENT

(71) Applicant: Bandai Namco Experience Inc., Tokyo (JP)

(72) Inventors: Fumio MUNEKATA, Kawasaki-shi (JP); Toshiya OHARA, Yamato-shi (JP); Kiyotaka MAENO, Tokyo (JP); Kei SHIRAI, Tokyo (JP)

(73) Assignee: Bandai Namco Experience Inc., Tokyo (JP)

(21) Appl. No.: 19/644,564

(22) Filed: Apr. 10, 2026

Related U.S. Application Data
(63) Continuation of application No. PCT/JP2024/038838, filed on Oct. 31, 2024.

(30) Foreign Application Priority Data
Nov. 6, 2023 (JP) 2023-189395

(51) Int. Cl. G05G 1/44; A63F 13/245

(52) U.S. Cl. CPC G05G 1/44; A63F 13/245; A63F 2300/8017

(57) ABSTRACT

Amusement game equipment includes a pedal portion, a load cell, and an elastic body disposed between the pedal portion and the load cell. When the pedal portion is operated, a pedal arm swings and abuts the elastic body, applying a load to the elastic body in accordance with the operating force. The load is transmitted to the load cell via the elastic body and a first plate portion that supports the elastic body, and is detected as a load. The amusement game equipment controls the movement of a game object based on the load detected by the load cell.

### CROSS REFERENCE TO RELATED APPLICATIONS

This application is a continuation of International Patent Application No. PCT/JP2024/038838, having an international filing date of October 31, 2024, which designated the United States, the entirety of which is incorporated herein by reference. Japanese Patent Application No.2023-189395 filed on November 6, 2023 is also incorporated herein by reference in its entirety.

### BACKGROUND OF THE INVENTION

As one type of arcade game apparatuses or arcade amusement game apparatuses, there is known amusement game equipment that executes a car racing game that imitates a car race or rally. Amusement game equipment that executes a car racing game is provided with a pedal operation input section such as an accelerator pedal and a brake pedal (for example, refer to Japanese Unexamined Patent Application Publication No. 7-124332).

For players of car racing games, the feel of brake operation is an important element, and is a key factor that determines the realism of the game. According to the technology disclosed in Japanese Unexamined Patent Application Publication No. 7-124332, the amount of depression of the brake pedal is detected with a potentiometer and is used to control an air cylinder, thereby recreating the feel of braking in a state where brake fade is occurring.

However, with the technology of Japanese Unexamined Patent Application Publication No. 7-124332, the amount of pedal depression is detected as a change in the pedal swing angle, making it difficult to detect small braking operations. That is, since the change in the swing angle is only slight, it is difficult to reliably detect small braking operations and reflect them in gameplay.

Furthermore, the brake pedal is a part that is subjected to a large force in amusement game equipment for car racing games and is operated frequently, so it tends to break down more easily than other parts. From the viewpoint of the administrator of the amusement game equipment, it is desirable that parts can be easily replaced in the event of a breakdown, and that the cost required for part replacement is low.

This issue is not limited to amusement game equipment for car racing games, but is applicable to any amusement game equipment that has a pedal operation input section, regardless of the game genre.

### BRIEF DESCRIPTION OF THE DRAWINGS

FIG. 1 is a side view of a configuration example of amusement game equipment.

FIG. 2 is a diagram illustrating a configuration example of functional sections implemented by a control section and examples of programs and data stored in the control section.

FIG. 3 is a perspective external view of a configuration example of a pedal assembly.

FIG. 4 is a cross-sectional view of an example of an internal structure of the pedal assembly.

FIG. 5 is a diagram for describing the operation of the pedal assembly (first state).

FIG. 6 is a diagram for describing the operation of the pedal assembly (second state).

FIG. 7 is a diagram for describing the operation of the pedal assembly (third state).

FIG. 8 is a diagram illustrating an example of an internal structure of a pedal assembly according to a modification example.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being "connected" or "coupled" to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided an amusement game equipment comprising:

a pedal portion;

a load cell;

an elastic body disposed between the pedal portion and the load cell; and

a control section configured to determine a parameter value used in controlling movement of a game object based on a detection signal from the load cell and control the movement of the game object.

According to the disclosure, in some embodiments, the amusement game equipment can create a pedal feel by the elastic body, and can detect with high resolution by the load cell the operating load applied by the user to the pedal portion and use the detected operating load to control the movement of the game object. Therefore, it is possible to implement amusement game equipment that can reliably detect small pedal operations.

In accordance with one of some embodiments, there is provided the above amusement game equipment, further comprising a support member configured to support the elastic body and the load cell in a predetermined positional relationship.

According to the disclosure, in some embodiments, the elastic body and the load cell can be maintained in a predetermined positional relationship. Therefore, the detection resolution of the load cell can be stably utilized.

In accordance with one of some embodiments, there is provided the above amusement game equipment, wherein

the support member has:

a first plate portion supporting the elastic body on an upper surface thereof;

a second plate portion supporting the load cell on an upper surface thereof; and

a hinge connecting the first plate portion and the second plate portion.

According to the disclosure, in some embodiments, the support member can be implemented inexpensively with a simple configuration.

In accordance with one of some embodiments, there is provided the above amusement game equipment, wherein

the pedal portion has a pedal plate and a pedal arm, and

the support member is placed below the pedal arm.

In accordance with one of some embodiments, there is provided the above the amusement game equipment, further comprising a swing shaft configured to swingably support the pedal portion.

According to the disclosure, in some embodiments, it is possible to preferably implement amusement game equipment that uses a suspended pedal. According to the disclosure, in some embodiments, the operating force (pedal force) applied by the user to operate the pedal portion can be transmitted directly to the load cell without changing the direction of force application, thereby enabling the load cell to be used without compromising its high detection resolution.

In accordance with one of some embodiments, there is provided the above the amusement game equipment, wherein the pedal arm has a metal fitting for abutment with the elastic body on a lower surface thereof.

According to the disclosure, in some embodiments, the metal fitting can ensure an appropriate contact area with the elastic body regardless of the shape of the pedal arm.

In accordance with one of some embodiments, there is provided the above the amusement game equipment, wherein the elastic body has a chamfered portion at a corner that comes into abutment with the pedal arm.

According to the disclosure, in some embodiments, the chamfered portion ensures a surface that can receive the displacement of the contact point as the pedal portion is further depressed, thereby making it possible to avoid stress concentration due to the load on the elastic body. Therefore, it is possible to reduce the shearing action on the corners, suppress the load, and improve the durability of the elastic body compared to when no chamfered portion is provided.

In accordance with one of some embodiments, there is provided the above the amusement game equipment, wherein the support member has an attachment portion that is detachable from a cabinet while supporting the elastic body and the load cell.

According to the disclosure, in some embodiments, when the elastic body or load cell needs replacement, the entire support member can be replaced, thereby reducing the effort and cost of replacement and shortening the time required for maintenance.

In accordance with one of some embodiments, there is provided the above the amusement game equipment, further comprising a pedal support mechanism having a spring that applies a biasing force in a direction opposing an operating force on the pedal portion, and configured to support the pedal portion at a position where there is play from a non-operational state to a state where stress corresponding to the operating force starts to act on the elastic body.

According to the disclosure, in some embodiments, it is possible to reproduce the "brake play" in a real automobile.

In accordance with one of some embodiments, there is provided the above the amusement game equipment, wherein the control section has a calibration control section configured to perform calibration based on the detection signal in a non-operational state in which stress corresponding to an operating force on the pedal portion is not acting on the elastic body.

According to the disclosure, in some embodiments, the zero point of the detection signal from the load cell can be appropriately corrected to achieve precise control of pedal operations.

Exemplary embodiments are described below. Note that the following exemplary embodiments do not in any way limit the scope of the content defined by the claims laid out herein. Note also that all of the elements described in the present embodiment should not necessarily be taken as essential elements.

Hereinafter, examples of embodiments of the present disclosure are described with reference to the drawings. However, modes to which the present disclosure is applicable are not limited to the following embodiments. Three orthogonal axes XYZ illustrated in the drawings commonly indicate directions of equipment.

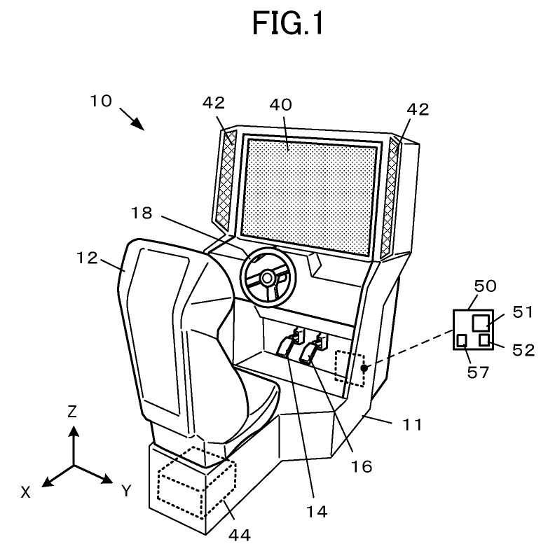

FIG. 1 is a side view of a configuration example of amusement game equipment 10 according to the present embodiment.

The amusement game equipment 10 is an apparatus for executing a car racing game by simulating the behavior of automobiles. The amusement game equipment 10 is one of the apparatuses also called arcade game apparatuses or arcade amusement game apparatuses. The amusement game equipment 10 includes a cabinet 11, a seat 12 on which a player is to sit, a brake pedal 14, an accelerator pedal 16, a steering wheel 18, a display 40, a speaker 42, a power supply device 44, and a control section 50. In addition, a shift lever, operation buttons, and a play cost payment device (for example, a coin acceptor, a prepaid card reader, or the like) may be installed as appropriate.

The brake pedal 14, the accelerator pedal 16, and the steering wheel 18 have sensors and switches for inputting game operations. These are installed in the cabinet 11 so as to form a virtual driver's seat of an automobile. The brake pedal 14, the accelerator pedal 16, and the steering wheel 18 each output a detection signal to the control section 50 in accordance with the amount of operation.

The display 40 is implemented by a liquid crystal panel display, an organic electroluminescence display, a projector, or the like, for example. The display 40 receives a video image signal from the control section 50 and displays the video image of the game screen.

The speaker 42 receives a sound signal from the control section 50 and emits game sounds (for example, sound effects, background music, operation sounds, operation guide sounds, and the like).

The control section 50 includes various microprocessors such as a central processing unit (CPU) 51, a graphics processing unit (GPU), and a digital signal processor (DSP), various IC memories 52 such as a VRAM, RAM, and ROM, and an interface IC 57. The interface IC 57 controls the exchange of signals between the brake pedal 14, accelerator pedal 16, steering wheel 18, display 40, speaker 42, and the like and the control section 50.

The control section 50 executes a program stored in the IC memory 52 and controls the game progress based on detection signals of operational inputs from the brake pedal 14, the accelerator pedal 16 and the steering wheel 18. The control section 50 then generates video image signals of the game screen and outputs them to the display 40 to display the game screen. The control section 50 also generates sound signals for game sounds and outputs them to the speaker 42 to emit the game sounds.

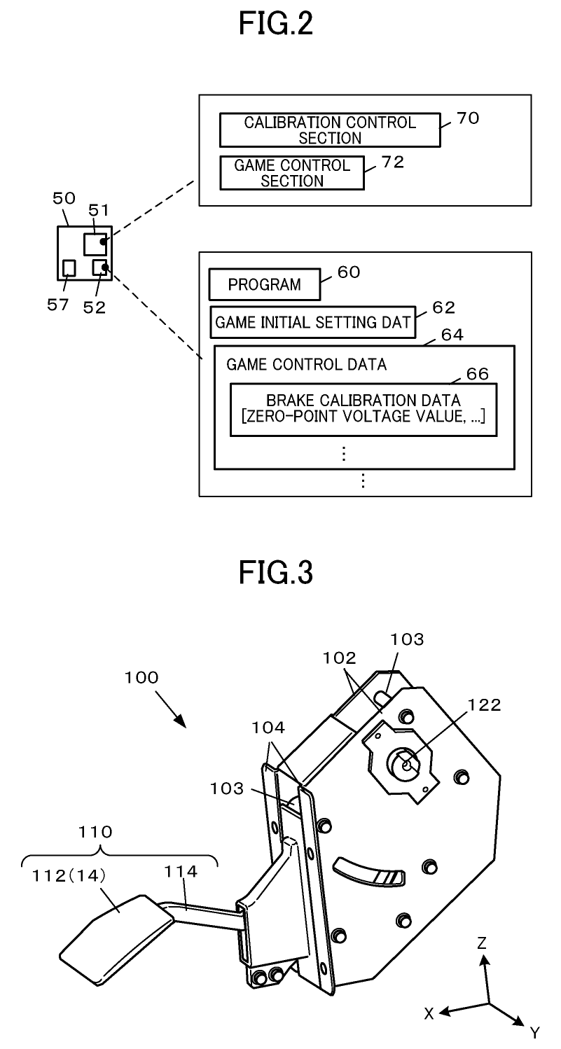

FIG. 2 is a diagram illustrating a configuration example of functional sections implemented by the control section 50 and examples of programs and data stored in the control section 50.

The control section 50 stores a program 60, game initial setting data 62, and game control data 64 in the IC memory 52.

The game initial setting data 62 includes data for setting a race course by arranging background objects in a three-dimensional virtual space, object model data for automobiles (game objects) that run on the race course, initial setting values for the automobiles’ capabilities, and the like.

The game control data 64 includes 1) course parameter values that indicate the state of the race course, and 2) driving state parameter values such as position coordinates, posture, speed, and acceleration of each automobile. The game control data 64 also includes 3) status parameter values such as attrition values for tires, engines, and body parts of each automobile, 4) remaining play time, and 5) game performance parameter values. The game control data 64 may include other types of data as appropriate, of course. For example, if the rules allow items to be used during the race, the game control data 64 may also include parameter values for the types of items that can be used and the number of remaining items.

The control section 50 executes the program 60 on the CPU 51 to implement the functions of a calibration control section 70 and a game control section 72.

The calibration control section 70 performs brake calibration based on a detection signal from a sensor related to the brake pedal 14 in a non-operational state where the brake pedal 14 is not being operated. For example, the calibration control section 70 includes a voltage value of the detection signal from the sensor related to the brake pedal 14 in a standby state before the start of gameplay, in brake calibration data 66 as the zero-point voltage value of the brake operation.

Some or all of the functions in the control section 50 may be implemented by an application specific integrated circuit (ASIC), a field programmable gate array (FPGA), or a System on a Chip (SoC).

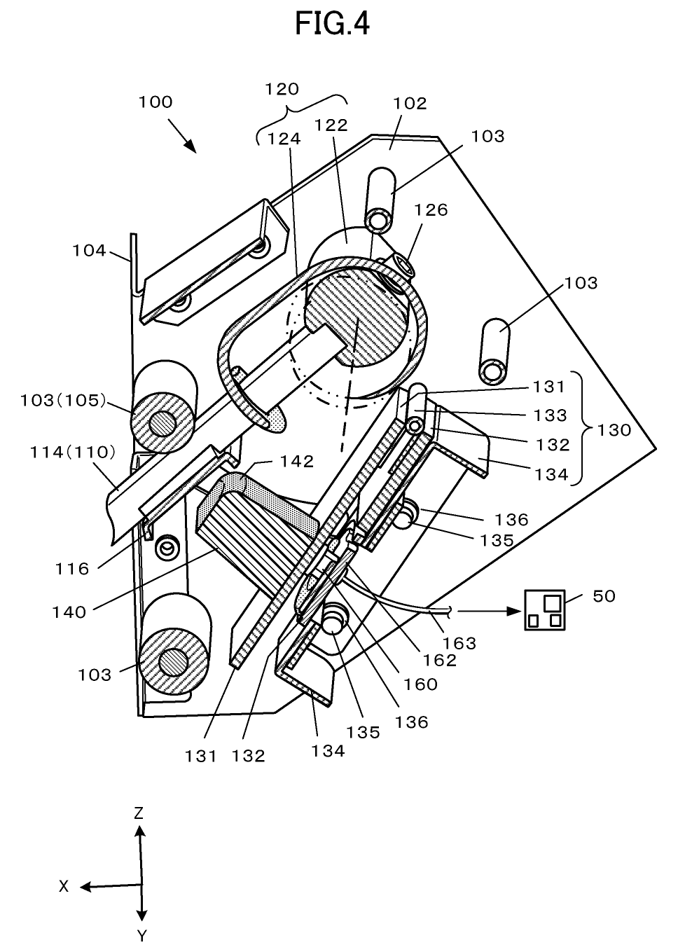

FIG. 3 is a perspective external view of a configuration example of a pedal assembly 100 including the brake pedal 14. FIG. 4 is an XZ cross-sectional view taken along an XZ plane, illustrating an example of an internal structure of the pedal assembly 100.

As illustrated in FIGS. 3 and 4, the pedal assembly 100 includes a case portion 102, a pedal portion 110, a pedal support mechanism 120, a support member 130, an elastic body 140, and a load cell 160.

The case portion 102 is made up of two opposing metal plate members with a spacer 103 in between, fixed with a plurality of bolts to define an internal space, and holds the pedal portion 110, the pedal support mechanism 120, the load cell 160, the elastic body 140, and the support member 130 together in a predetermined positional relationship. The case portion 102 is fixed to the inside of the cabinet 11 by a fixing portion 104 with a bolt, and is not visible to the player.

The pedal portion 110 has a pedal plate 112 that serves as the brake pedal 14 and to which a player applies a pedal force, and a pedal arm 114. The pedal plate 112 is fixed to one end of the pedal arm 114. The other end of the pedal arm 114 is fixed to the pedal support mechanism 120.

As illustrated in FIG. 4, the pedal arm 114 has a metal fitting 116 on its lower surface. The metal fitting 116 has a flat surface facing the elastic body 140 and has a contact surface that is wider than the lower surface of the pedal arm 114 for contacting the elastic body 140. A portion of the lower surface of the pedal arm 114 may be deformed to serve as a substitute for the metal fitting 116. Alternatively, a portion of the pedal arm 114 may be bent to serve as the metal fitting 116.

In the non-operational state where no pedal operation is input to the brake pedal 14, the pedal support mechanism 120 supports the brake pedal 14 in a position where the pedal arm 114 (metal fitting 116) is not in contact with the elastic body 140 and a gap G is present. The position of the pedal arm 114 in the non-operational state is determined by the upper surface of the pedal arm 114 abutting against a stopper 105 that also serves as a spacer 103 of the case portion 102.

The pedal support mechanism 120 has a swing shaft 122 and a torsion coil spring 124.

The other end of the pedal arm 114 is fixed to the swing shaft 122, which supports the pedal portion 110 so as to be swingable in the up-and-down direction. In the example of FIG. 4, the other end of the pedal arm 114 is inserted into the recess of the swing shaft 122, and the pedal arm 114 is screwed and fixed with a bolt 126 that passes through the swing shaft 122 from the opposite side to the recess. However, other fixing methods may be used.

The torsion coil spring 124 has one end that is hooked to the pedal arm 114 so as to abut against the lower surface of the pedal arm 114, a coil portion that is wound around the swing shaft 122, and the other end that is engaged with the inner surface of the case portion 102. For example, the other end may be hooked and locked onto the spacer 103 of the case portion 102.

Accordingly, the pedal portion 110 is supported by the pedal support mechanism 120 so as to be swingable in the up-and-down direction, and the pedal arm 114 is biased by the torsion coil spring 124 in a direction that pushes the pedal plate 112 upward. The torsion coil spring 124 applies a biasing force in a direction opposing the operating force on the brake pedal 14.

The support member 130 is placed below the pedal arm 114 and supports the elastic body 140 and the load cell 160 in a predetermined positional relationship. Specifically, the support member 130 has a first plate portion 131 that supports the elastic body 140 on its upper surface, a second plate portion 132 that supports the load cell 160 on its upper surface, a hinge 133 that connects the first plate portion 131 and the second plate portion 132, and an attachment portion 134 for attaching these portions to the case portion 102 in a detachable manner.

The first plate portion 131 and the second plate portion 132 are rectangular plate members having long sides in the longitudinal direction of the pedal arm 114. The first plate portion 131 and the second plate portion 132 are each fixed to a blade of a hinge 133 at an end portion close to the swing shaft 122. The axial direction of the hinge 133 is parallel or approximately parallel to the swing shaft 122. Therefore, the first plate portion 131 can swing up and down relative to the second plate portion 132. Its swing direction is along the swing direction of the pedal arm 114 relative to the swing shaft 122.

The first plate portion 131 and the hinge 133, and the second plate portion 132 and the hinge 133 are fixed to each other using small screws, but spot welding or adhesive may also be used. The first plate portion 131 and the second plate portion 132 may be originally the blades of the hinge 133.

The attachment portion 134 is a sheet metal part that forms a shelf portion on the inner surface of the case portion 102, and has burring nut portions 136 into which fixing bolts 135 are screwed. The attachment portion 134 is fixed to a predetermined position on the inner surface of the case portion 102 by the fixing bolts 135. The second plate portion 132 is fixed onto the shelf surface created by fixing the attachment portion 134 to the case portion 102. The fixing may be performed using small screws, spot welding, or adhesive.

The elastic body 140 is fixed to the upper surface of the first plate portion 131. For fixing, small screws or adhesive may be used. Focusing on the elastic body 140, it can be said that the elastic body 140 is placed between the pedal arm 114 of the pedal portion 110 and the load cell 160 by the support member 130.

The elastic body 140 is a solid elastic body made of synthetic rubber, hard sponge material, or the like, for example. The elastic body 140 has a general shape of a truncated pyramid or a slightly elongated rectangular parallelepiped, and has a chamfered portion 142 at the corner near the swing shaft 122, that is, at the corner of the upper part near the hinge 133 of the support member 130. The chamfered portion 142 has an outwardly convex curved surface.

The load cell 160 is fixed to the upper surface of the second plate portion 132 of the support member 130 (the surface facing the first plate portion 131).

The load cell 160 is fixed to the second plate portion 132 via a cell holder 162 in a posture where the direction of load detection is aligned with the vertical swing direction of the pedal portion 110. A signal line 163 of the load cell 160 is connected to the control section 50, and a detection signal is input to the control section 50.

The support member 130 has a simple structure, yet can support the elastic body 140 and the load cell 160 in a predetermined positional relationship. Because of its simple structure, the support member 130 is less likely to break down and can be implemented at low cost.

FIGS. 5, 6, and 7 are diagrams for describing the operation of the pedal assembly 100 in response to an operation on the brake pedal 14 (a braking operation).

FIG. 5 illustrates a non-operational state in which the player is not stepping on the brake pedal 14.

In the non-operational state, the pedal portion 110 is biased by the pedal support mechanism 120 in a direction in which the pedal plate 112 is lifted upward. The upper surface of the pedal arm 114 abuts against the spacer 103, which also serves as a stopper 105. At this time, there is generated the gap G between the metal fitting 116 of the pedal arm 114 and the elastic body 140. This gap G is the "brake play" in a real automobile.

In the non-operational state, the gap G prevents stress corresponding to the operating force on the brake pedal 14 from acting on the elastic body 140. However, since the load of the elastic body 140 and the first plate portion 131 acts on the load cell 160, the load cell 160 outputs a detection signal of a voltage value corresponding to this load to the control section 50 even in the non-operational state. The calibration control section 70 executes calibration based on the detection signal from the load cell 160 in the non-operational state.

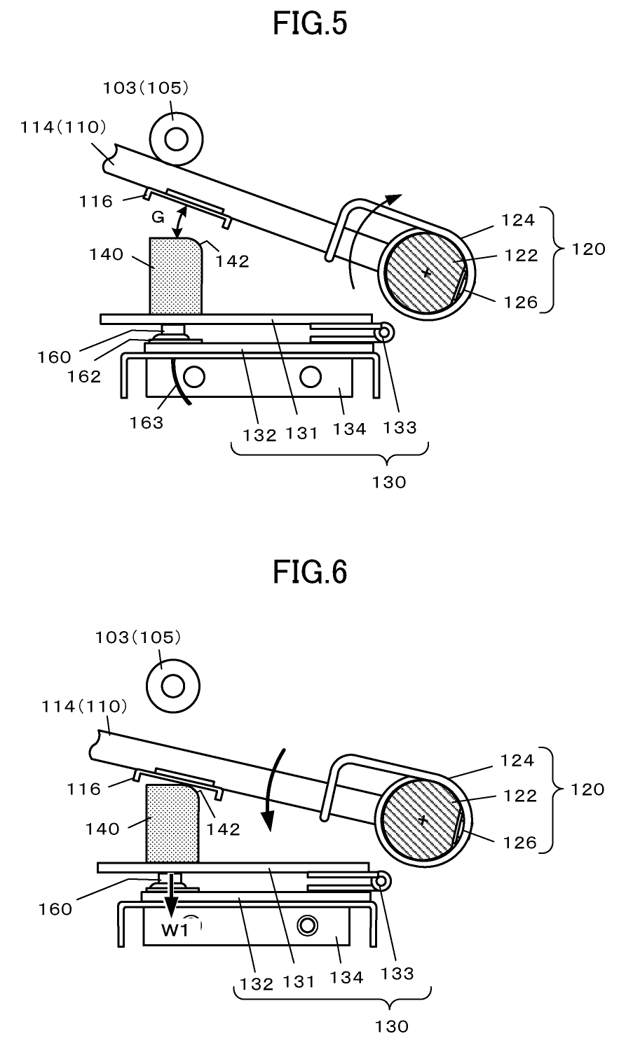

As illustrated in FIG. 6, when the player depresses the brake pedal 14 to start braking, the pedal portion 110 descends. When the pedal arm 114 swings downward by the gap G, the lower surface of the metal fitting 116 comes into abutment with the chamfered portion 142 of the elastic body 140. Then, the pedal force of the player is transmitted to the elastic body 140 via the pedal arm 114, and the elastic body 140 begins to be compressed. The repulsive force of the elastic body 140 against the compression is transmitted to the foot of the player who presses the brake pedal 14, and the player feels the actuation of the brake. The pedal force is transmitted to the load cell 160 via the elastic body 140 and the first plate portion 131 and measured as a load W1.

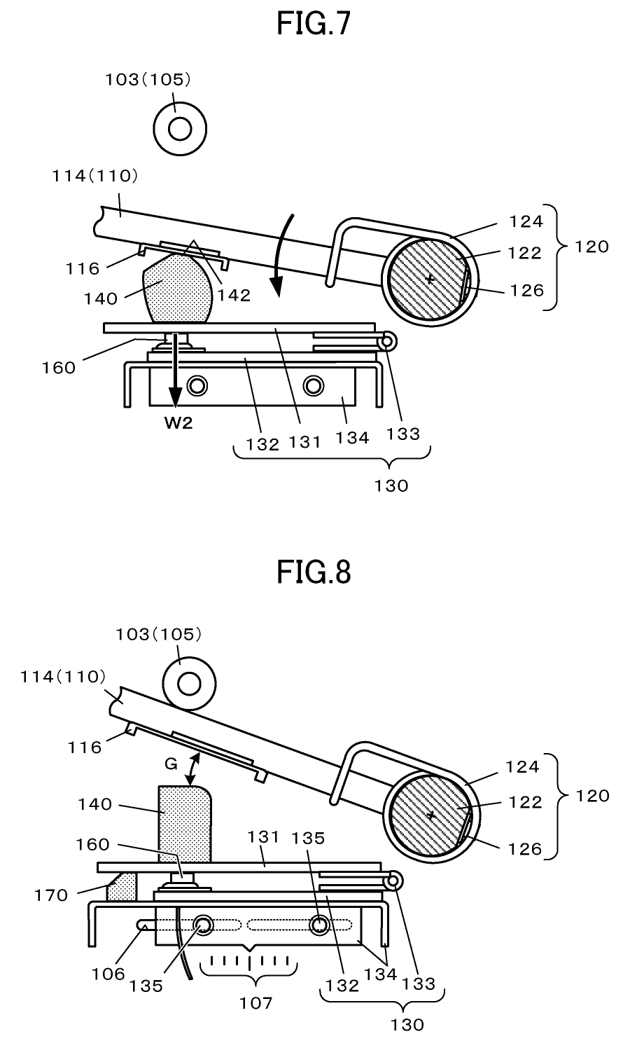

When the player further depresses the brake pedal 14, the elastic deformation of the elastic body 140 progresses, and the repulsive force of the elastic body 140 further increases, as illustrated in FIG. 7. A repulsive force corresponding to the depression of the pedal is transmitted to the player via the pedal arm 114, giving the player the sensation of braking. The further increased pedal force is transmitted to the load cell 160 via the elastic body 140 and the first plate portion 131 and measured as a load W2 (> W1).

After the pedal arm 114 and the elastic body 140 come into abutment with each other, a load that exceeds the load acting in the non-operational state acts on the load cell 160. The load cell 160 outputs a voltage value exceeding the calibrated zero-point voltage value to the control section 50. The game control section 72 of the control section 50 determines a braking force corresponding to the voltage value exceeding the zero-point voltage value as one of parameter values used in controlling the movement of the automobile (game object) by the player, and controls the movement of the automobile by the player.

The load cell 160 directly receives the pedal force applied by the player to the brake pedal 14, and can therefore detect the amount of braking operation with higher resolution than in a configuration in which the swing of the brake pedal 14 is detected as a rotational movement according to conventional techniques. This is also due to the fact that the first plate portion 131 receives the load that the elastic body 140 receives from the pedal arm 114 as a rigid surface and transmits the load to the load cell 160, thereby preventing fluctuations in the detected load that would occur when the elastic body 140 directly abuts with the load cell 160.

Therefore, it is possible to detect small braking operations reliably and with high accuracy and reflect the detection results in game control.

Furthermore, in the amusement game equipment 10, the durability of the elastic body 140 is improved, and the frequency of replacement of consumables is reduced.

That is, focusing on the action of the load on the elastic body 140, the load acts on the corner of the elastic body 140 close to the swing shaft 122 from an obliquely upward direction. Therefore, the elastic body 140 undergoes both tilting deformation and compressive deformation at the same time, and as the depression progresses, the position of the point of action shifts. If the elastic body 140 had sharp corners without the chamfered portion 142, the load would be concentrated at the corners and combined with the subsequent positional shift of the load application point, so that the load on the elastic body 140 would act to bend the corner. As a result, the corners of the elastic body 140 would quickly become chipped or suffer excessive wear. The chipping then causes further stress concentration, which leads to further chipping and wear.

However, in the amusement game equipment 10, the elastic body 140 is provided with the chamfered portion 142, and there occurs almost no shearing action that would tilt the sharp corner. Furthermore, even when the depression progresses, the position of the load application point moves so as to slide along the chamfered portion 142, so the load hardly acts to shear around the chamfered portion 142. Therefore, the above-mentioned concentration of load on the corners of the elastic body 140 and subsequent attrition of the corners do not occur, and the durability of the elastic body 140 can be improved compared to when the chamfered portion 142 is not provided.

Furthermore, focusing on the contact area between the pedal arm 114 and the elastic body 140, the contact area between them increases as the pedal arm 114 is depressed further and the elastic deformation of the elastic body 140 progresses. If the metal fitting 116 is not provided, the contactable area is limited to the width of the bottom surface of the pedal arm 114. If the contact area exceeds the width of the lower surface of the pedal arm 114, the corners of the lower surface of the pedal arm 114 will come into contact with the elastic body 140, resulting in stress concentrations that may induce chipping.

However, in the amusement game equipment 10, the metal fitting 116 increases the area contactable with the elastic body 140. Therefore, even if the contact surface widens as the depression progresses and the elastic body 140 elastically deforms, surface contact is always maintained, and no stress concentration that may induce chipping of the corners of the elastic body 140 occurs. This improves the durability of the elastic body 140 compared to when the metal fitting 116 is not provided.

In the amusement game equipment 10, even when replacement of the elastic body 140 or the load cell 160 becomes necessary, the effect of facilitating the replacement work can be obtained.

That is, the elastic body 140 and the load cell 160, which are assumed to be consumables, are integrally fixed to the case portion 102 by the support member 130, which includes the attachment portion 134. Therefore, when the elastic body 140 or the load cell 160 needs to be replaced, repair can be performed simply by removing and replacing the entire support member 130. Part replacement is easy in the event of a malfunction, the labor costs required for part replacement can be kept low, and maintenance time can also be shortened.

### Modification Examples

The embodiments to which the present disclosure is applied have been described above. However, the mode to which the present disclosure is applicable is not limited to the embodiments, and various modifications may be made as appropriate, such as adding other components, or omitting or changing some of the components.

### Modification Example 1

For example, the game genre is not limited to games that simulate driving an automobile as long as the game requires pedal operation. For example, the game may be a game that simulates flying an airplane, a game that simulates driving a motorcycle, or a game that simulates manipulating a robot.

### Modification Example 2

As illustrated in FIG. 8, a second elastic body 170 may be provided between a first plate portion 131 and a second plate portion 132. The second elastic body 170 may be a solid elastic body such as synthetic rubber or hard sponge, or may be a coil spring, a leaf spring, or the like.

The height of the second elastic body 170 from the top surface of the second plate portion 132 is set so as to support the relative position between the first plate portion 131 and the second plate portion 132 in a non-operational state at a position where the weight of an elastic body 140 does not act on a load cell 160. By preparing a plurality of types of second elastic bodies 170 with different elastic properties and shapes and making them interchangeable, it is possible to customize the feel of the brake pedal on site.

Furthermore, the position at which a support member 130 is fixed to a case portion 102 may be made variable.

For example, the relative distance between the support member 130 and a swing shaft 122 can be changed by elongating an insertion hole 106 for a fixing bolt 135 provided in the case portion 102 to change the tightening position of the fixing bolt 135. With this configuration, the brake touch can be easily customized by changing the lever ratio at which to transmit the operating force on the pedal portion 110 to the elastic body 140 at the site where the amusement game equipment 10 is in use. Furthermore, the frequency of part replacement can be reduced by, if the elastic body 140 becomes worn, changing the fixing position of the support member 130 to compensate for the deterioration of the brake touch due to the wear. It is preferable to provide a scale 107 on the case portion 102 for determining the default position of the support member 130.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. Amusement game equipment comprising:
a pedal portion;
a load cell;
an elastic body disposed between the pedal portion and the load cell; and
a control section configured to determine a parameter value used in controlling movement of a game object based on a detection signal from the load cell and control the movement of the game object.

2. The amusement game equipment as defined in claim 1, further comprising a support member configured to support the elastic body and the load cell in a predetermined positional relationship.

3. The amusement game equipment as defined in claim 2, wherein
the support member has:
a first plate portion supporting the elastic body on an upper surface thereof;
a second plate portion supporting the load cell on an upper surface thereof; and
a hinge connecting the first plate portion and the second plate portion.

4. The amusement game equipment as defined in claim 3, wherein
the pedal portion has a pedal plate and a pedal arm, and
the support member is placed below the pedal arm.

5. The amusement game equipment as defined in claim 4, further comprising a swing shaft configured to swingably support the pedal portion.

6. The amusement game equipment as defined in claim 4, wherein the pedal arm has a metal fitting for abutment with the elastic body on a lower surface thereof.

7. The amusement game equipment as defined in claim 4, wherein the elastic body has a chamfered portion at a corner that comes into abutment with the pedal arm.

8. The amusement game equipment as defined in claim 6, wherein the elastic body has a chamfered portion at a corner that comes into abutment with the pedal arm.

9. The amusement game equipment as defined in claim 3, wherein the support member has an attachment portion that is detachable from a cabinet while supporting the elastic body and the load cell.

10. The amusement game equipment as defined in claim 4, wherein the support member has an attachment portion that is detachable from a cabinet while supporting the elastic body and the load cell.

11. The amusement game equipment as defined in claim 1, further comprising a pedal support mechanism having a spring that applies a biasing force in a direction opposing an operating force on the pedal portion, and configured to support the pedal portion at a position where there is play from a non-operational state to a state where stress corresponding to the operating force starts to act on the elastic body.

12. The amusement game equipment as defined in claim 1, wherein the control section has a calibration control section configured to perform calibration based on the detection signal in a non-operational state in which stress corresponding to an operating force on the pedal portion is not acting on the elastic body.

13. The amusement game equipment as defined in claim 11, wherein the control section has a calibration control section configured to perform calibration based on the detection signal in a non-operational state in which stress corresponding to an operating force on the pedal portion is not acting on the elastic body.
